(19) United States
(12) Patent Application Publication
(10) Pub. No.: US 2006/0208487 A1
(43) Pub. Date: Sep. 21, 2006

(54) Symmetrical hose coupling

(76) Inventor: Johann Ambrosi, Herbrechtingen (DE)

Correspondence Address: LAW OFFICES OF STUART J. FRIEDMAN, 28930 RIDGE ROAD, MT. AIRY, MD, 21771, US

(21) Appl. No.: 10/527,967

(22) PCT Filed: Sep. 17, 2003
(86) PCT No.: PCT/EP03/10331

§ 371 Date: Sep. 26, 2005

(30) Foreign Application Priority Data
Sep. 18, 2002 (EP) 202 14 463.1

(51) Int. Cl. F16L 25/00; F16L 21/00

(52) U.S. Cl. 285/396; 285/402

(57) ABSTRACT

A symmetrical hose coupling has two coupling halves that each include a fixing connection and a cam ring. Each fixing connection is designed in one piece with the cam ring. Further, the cams are made hook-shaped in the tangential direction and have radial surfaces transmitting axial forces. The cams of the coupling halves engage into each other during coupling, the surfaces transmitting axial forces engaging behind each other in a bayonet-type fit.

The invention relates to a symmetrical hose coupling having coupling halves that include a fixing connection and a cam ring.

Symmetrical hose couplings of this type are known as Storz couplings and are widely used in particular in firefighting. In these couplings, the cam ring is rotatably arranged on the fixing connection. The cams arranged on the periphery of the cam ring are hook-shaped in the radial direction of extension and during the coupling process engage into the respective other cam ring through an opening on the end face, to then engage behind a shoulder by rotation of the cam rings in relation to each other, the shoulder extending in the peripheral direction and ascending in the axial direction. The surfaces transmitting axial forces extend in the peripheral direction on both coupling halves. An advantage with these couplings is that only the cam rings are rotated, whereas the fixing connections and the hoses mounted thereon are not rotated during coupling. However, the cam rings have a substantially larger outside diameter than the fixing connection along with the hose. For large-volume hoses having a diameter in the range of several hundred millimeters, the result is an outside diameter of the cam rings that is hardly acceptable. A further drawback is that owing to the relatively large coupling path required, the force-transmitting parts are restricted as far as their cross sections and, hence, their load-bearing capacity is concerned, as a result of which their design for the transmission of great forces as is necessary in the event of higher internal pressures, pulling or bending of the hose pipe or in case of a combination of such influences, may be realized only by an unreasonable increase in size of the coupling diameter or by using materials having greater strengths, which, in turn, will lead to problems in handling and production.

The invention provides a hose coupling which is capable of transmitting large forces without the largest coupling diameter having to be excessively increased in proportion to the hose diameter and without great demands having to be made on material strength and production engineering. According to the invention, the fixing connection is designed in one piece with the cam ring. The cams are made hook-shaped in the tangential direction and are provided with radial surfaces transmitting axial forces. The cams of the coupling halves engage into each other during coupling, the surfaces transmitting axial forces engaging behind each other in a bayonet-type fit. In the hose coupling according to the invention, the surfaces transmitting axial forces are formed on the cams. The cams arranged on the periphery of the cam ring determine the largest outside diameter of the coupling, which is larger than the outside diameter of the fixing connection only by the radial dimension of the cams. The fixing connections along with the cam rings do need to be twisted in relation to each other during coupling, but only through a relatively small angle of rotation which roughly corresponds to the distance between two neighboring cams in the peripheral direction. The coupling halves may be produced in a casting process from a conventional material such as aluminum.

In the preferred embodiment of the hose coupling, the surfaces, transmitting axial forces, of the cams are configured to be inclined in relation to the tangential direction and as related to the relative rotation during coupling. In this way, a latching effect is produced during coupling, which counteracts, any reverse rotation of the coupling halves. An axial ascent of the radial cam faces sliding on each other during coupling may be dispensed with if the coupling halves are provided with shaped sealing rings which ensure a sealing effect by a hydraulic internal pressure even in the absence of an axial pressing force. Accordingly, in the preferred embodiment, the cam ring or else the fixing connection has an annular undercut in its end face facing the respective other coupling half and radially inwardly of the cams. The undercut is provided for receiving a shaped sealing ring having a sealing lip which in the uncoupled condition protrudes axially beyond the end face of the cam ring and is directed inwardly. In the coupling process, first the sealing lips of the two coupling halves come into contact with each other. The coupling halves are then pressed axially against each other so that the cams may engage into each other. The sealing effect is produced in a known manner by the hydraulic pressure that presses the sealing rings against each other and against the sealing surfaces defining the undercut.

For locking the hose coupling in the coupled condition, blocking means are inserted between at least two adjacent cams. As an alternative, use is made of retaining means acting in the peripheral direction and holding two adjacent cams together.

Further features and advantages of the invention will become apparent from the following description given with reference to the accompanying drawings in which:

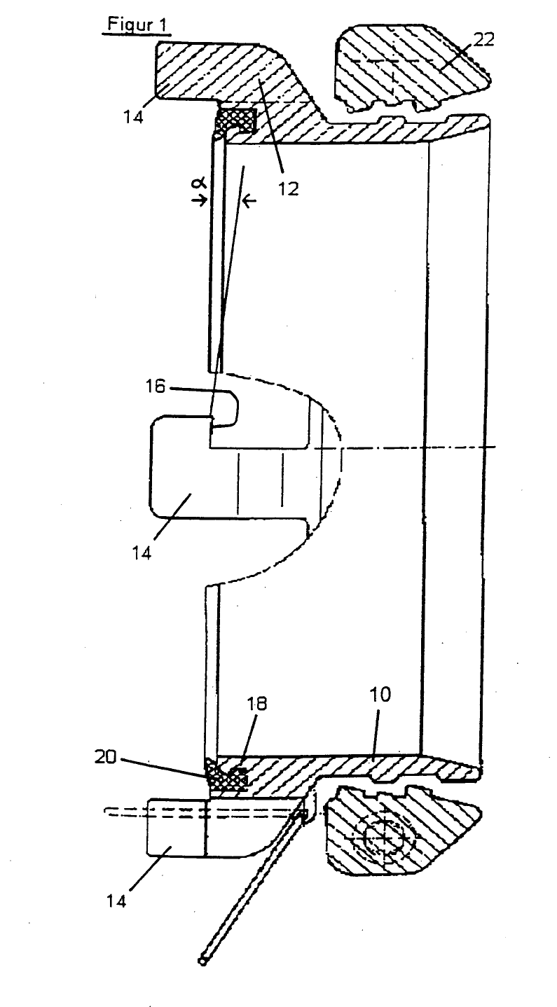

FIG. 1 shows a diametrical section of a coupling half;

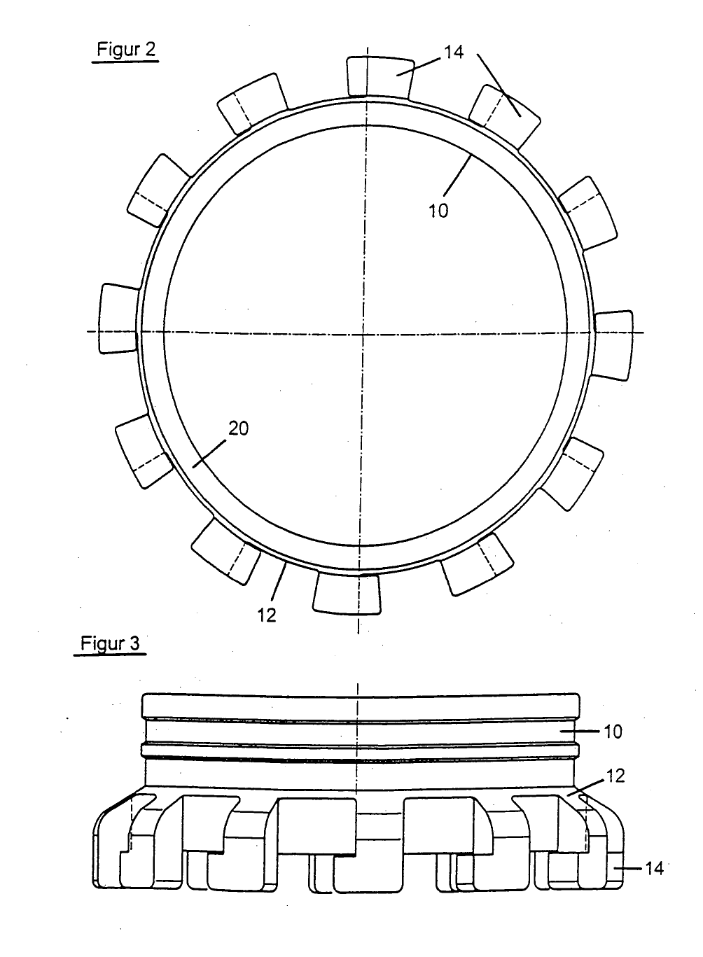

FIG. 2 shows a front view of a coupling half;

FIG. 3 shows a side view of a coupling half;

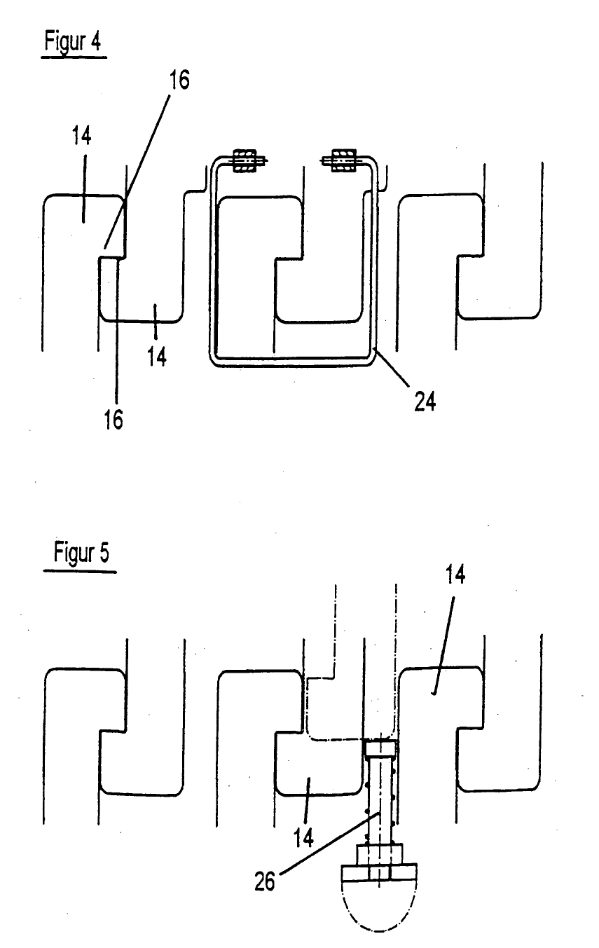

FIG. 4 shows a developed view of the coupled cams with a first embodiment of a locking mechanism;

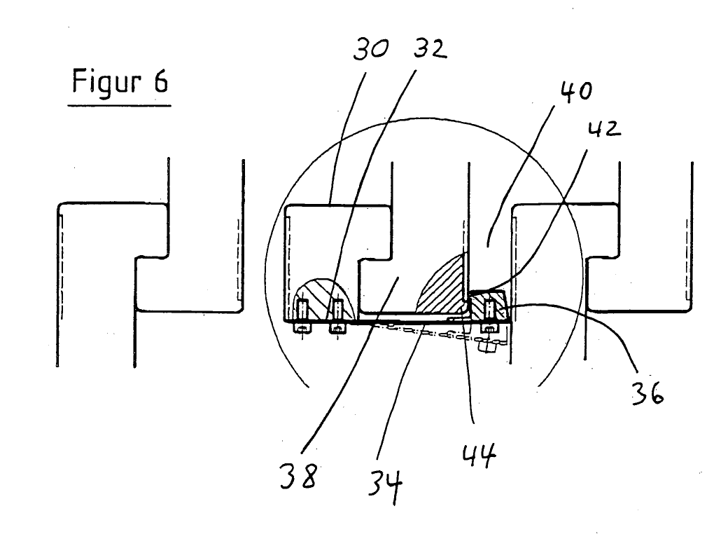

FIG. 5 shows a developed view of the coupled cams with a locking mechanism according to a second embodiment; and

FIG. 6 shows a developed view of the coupled cams with a locking mechanism according to a third embodiment.

The symmetrical hose coupling consists of two identical coupling halves, one of which is illustrated in FIG. 1. Each coupling half consists of a cylindrical fixing connection 10 and a cam ring 12 formed in one piece therewith, the cam ring 12 having radially projecting cams 14 arranged on the periphery thereof. The cams 14 are hook-shaped in the tangential direction of extension. In the embodiment shown, a total of twelve cams 14 are arranged on the periphery of the cam ring 12 at equal angular distances. The gaps remaining between the cams are somewhat wider than the width of the cams in the peripheral direction, so that the cams of the two coupling halves may engage into each other for coupling purposes. The surfaces 16 transmitting axial forces are configured on the cams 14 and have a radial extension. At the same time, the surfaces 16 transmitting axial forces are inclined by a few degrees with respect to the tangential direction, as indicated by an angle α in FIG. 1.

The end face of the cam ring 12 facing the respective other coupling half is provided with an annular undercut 18 radially inwardly of the cams 14, which accommodates a shaped sealing ring 20. The shaped sealing ring 20 has an inwardly pointing sealing lip which in the uncoupled condition protrudes axially beyond the end face of the cam ring 12. A hose (not shown) may be secured to the fixing connection 10 by means of a ring 22 composed of segments. By applying tangential screwing forces, the segments of this ring 22 are pressed with an interlocking and frictional fit in the radial direction against the fixing connection 10 made to have surrounding grooves. As an alternative to the embodiment of the fixing connection 10 as shown, designs are provided having a threaded connection (solid fire hose coupling) or a closure cap (cap fire hose coupling).

The illustrated embodiment having twelve cams is dimensioned for an inside hose diameter of 305 mm and has a largest outside diameter of 372 mm. Depending on the diameter and pressure load, the number of the cams may be larger or smaller.

In the coupled condition, as illustrated in FIGS. 4 and 5, the cams of the two coupling halves engage into each other in a bayonet-type fit, with the surfaces 16 transmitting axial forces resting on each other. The inclination of these surfaces 16 produces a latching effect which counteracts a reverse rotation of the coupling halves. An additional locking is attained by using a wire bracket 24 shown in FIG. 4, which holds two adjacent cams together in the peripheral direction. In the embodiment shown in FIG. 5, a locking mechanism is provided which includes a spring-loaded pin 26. The spring-loaded pin 26 reaches into the gap between two peripherally adjacent cams 14, in this way blocking them automatically against any unintentional reverse rotation.

In the embodiment of the locking mechanism shown in FIG. 6, a leaf spring 34 is attached on a surface 32 parallel to the cam head 30. A spacer element 36 is attached to the free end of the leaf spring 34. During the coupling process, the spacer element 36 is initially pushed away by the countercam 38, accompanied by a deflection of the leaf spring 34. In the fully coupled condition, the spacer element 36 will spring back into the gap 40 between the cams. On its face facing the countercam 38 and on the end facing away from the leaf spring 34, the spacer element 36 carries a nose 42 which upon application of a force engages behind a hook-shaped projection 44 on the head end of the countercam 38 to prevent the spacer element 36 from being lifted out of the gap 40.

1.-5. (canceled)

6. A symmetrical hose coupling comprising a pair of like coupling members, each of the coupling members having a cylindrical hose attachment connector and a cam ring integrally formed with the cylindrical hose attachment connector, the cam ring having a plurality of integral cams that project on the periphery of the cam ring in a radial direction, said cams being hook-shaped in a tangential direction of the cam ring and each having a radial surface area for transmitting an axial force, and the cams of the coupling members engaging into each other in a bayonet-type fashion.

7. The hose coupling, as claimed in claim 6, wherein the radial surface areas of the cams are inclined in relation to the tangential direction and in relation to a radial plane.

8. The hose coupling, as claimed in claim 6, wherein the cam ring has an annular front face radially inwardly of the cams and an annular undercut groove is recessed in the annular front face for receiving a shaped sealing ring having a sealing lip which protrudes axially beyond the front face of the cam ring.

9. The hose coupling, as claimed in claim 6, wherein the cams are arranged at distances from each other in a peripheral direction which are only slightly greater than the cams are wide in the peripheral direction.

10. The hose coupling, as claimed in claim 6, wherein blocking means are provided for locking the pair of coupling members with each other in a coupled condition.
